(19) United States
(12) Patent Application Publication
(10) Pub. No.: US 2014/0204727 A1
(43) Pub. Date: Jul. 24, 2014

(54) REDUNDANT CONTROL OF SELF-CONFIGURING WIRELESS NETWORK

(71) Applicant: Oplink Communications, Inc., (US)

(72) Inventors: Keqin Gu, Fremont, CA (US); Longgang Huang, Fremont, CA (US); Kuochun Lee, Fremont, CA (US)

(73) Assignee: Oplink Communications, Inc., Fremont, CA (US)

(21) Appl. No.: 13/749,457

(22) Filed: Jan. 24, 2013

(51) Int. Cl. H04W 12/04

(52) U.S. Cl. CPC H04W 12/04
USPC 370/217

(57) ABSTRACT

Methods, systems, and apparatus, are provided for wireless networking. In some implementations, a self-configuring wireless system includes one or more wireless network devices; a primary access point device; and a secondary access point device; wherein the primary access point device and the at least one wireless network device are preconfigured with a respective key so as to enable the primary access point device to establish a secure wireless network with the at least one network device using the respective keys, and wherein the secondary access point device is configured assume coordination for the self-configuring wireless system if a fault associated with the primary access point device occurs.

### BACKGROUND OF THE INVENTION

The present specification generally relates to secure wireless network systems and in particular, to a self-configuring secure wireless network.

Wireless networks are typically advantageous over their wired counterparts, because they eliminate the need for stringing lengths of wire around a network site. This is especially useful in a home or enterprise security system in which multiple surveillance cameras and various sensors may be strategically placed around, both inside and outside, the home or office. Wireless networks further have the advantage that they cannot be easily circumvented by merely cutting the wired connections to network devices.

FIG. 1 illustrates, as an example, a block diagram of a wireless (e.g., WiFi) network 10 as commonly found in homes. A modem 11 is adapted to access the Internet through a broadband Internet Service Provider (ISP). A WiFi router 13 is wire-connected (indicated by solid line) to the modem 11 through an Ethernet cable 14. Alternatively, a device combining the functions of the modem 11 and the WiFi router 13 may be used. A computer 12 may be wire-connected to the WiFi router 13 through another Ethernet cable 18. WiFi enabled devices are wirelessly connected (indicated by dotted lines) to the WiFi router 13 using, for example, the IEEE 802.11 standard for WiFi communications. Examples of such WiFi enabled devices include continuously connected devices such as a WiFi enabled camera 15 and a WiFi enabled sensor 17. A general WiFi enabled device 16 is also shown which may be a continuously connected device, such as a WiFi enabled printer, or a temporarily connected device such as a laptop computer, tablet computer, or mobile phone.

Many WiFi enabled devices such as a laptop computer, tablet computer, or mobile phone, provide a user interface in the form of a display and keypad so that connecting these devices to an established WiFi network is reasonably easy as long as the user has the WiFi key readily available. In particular, the user interface provides means for a user to select an available WiFi network to connect to and means for the user to enter a WiFi key (also referred to as a network password) to access the selected WiFi network. The WiFi key may be generated according to either Wired Equivalent Privacy (WEP) or WiFi Protected Access (WPA). However, some WiFi enabled devices do not have such a user interface. Adding these WiFi enabled devices to an established WiFi network is a much more challenging task. Many less experienced end users may find it too challenging and eventually return such WiFi enabled devices back to their point of purchase in frustration after multiple unsatisfactory attempts to make a workable connection.

FIG. 2 illustrates, as an example, a block diagram of wired-connections that may be used for adding the WiFi enabled camera 15 to the WiFi network 10. In this example, the WiFi enabled camera 15 does not have a user interface which would allow a user to directly input the WiFi key. Therefore, the WiFi enabled camera 15 is temporarily wire-connected to the computer 12 using an Ethernet cable 19 so that the user may use the computer's display and keyboard to provide the WiFi key to the WiFi enabled camera 15.

However, providing the WiFi key to the camera 15 is not necessarily a straightforward process. To do this, the user may need to first reset the computer 12 to a new IP address, such as 192.168.0.10, that is within the same subnet as camera 15. The user would then open a browser on the computer 12 and go to IP address 192.168.0.1. The user may then select the WiFi access point and input the WiFi key using the computer 12. After providing the WiFi key to the WiFi enabled camera 15, the user may disconnect the wired-connection between the camera 15 and computer 12 and change the computer IP address back to its original IP address.

As a simpler alternative to the approach described above, the WiFi enabled camera 15 may be temporarily wire-connected to the WiFi router 13 instead of the computer 12. In this alternative conventional approach, special installation software, which will simplify the camera installation procedure, is installed on the computer 12. After the WiFi enabled camera 15 is installed or connected to the WiFi network 10, the wire-connection between the WiFi enabled camera 15 and the WiFi router 13 is removed. Although simpler than the first approach described above, this approach still requires the use of an Ethernet cable, which not only adds to the cost and inconvenience of the installation, but may be problematic when the WiFi enabled camera 15 has already been physically mounted in a location that is not easily accessible and distant from the computer 12 and/or WiFi router 13. This may often be the case when the WiFi enabled camera 15 is to be used for surveillance purposes in a home security system.

As a still simpler alternative to the approaches described above, the WiFi Protective Setup (WPS) is a computing standard that attempts to allow easy establishment of a WiFi network. A conventional method using the standard is a push-button method in which the user clicks a button on both the WiFi router 13 and the WiFi enabled device within a certain period of time. The WiFi router 13 would then pass the WiFi key to the WiFi enabled device and add the device to the WiFi network 10. Although simple to use and implement, WPS has been shown to be vulnerable to brute-force attacks. A major security flaw has also been revealed that allows a remote attacker to recover the WiFi key. As a result, users have been urged to turn off the WPS feature on their WiFi routers.

Even if the user is able to properly perform one of the above procedures, the addition of a new WiFi enabled device to the WiFi network may still be thwarted if the user forgets the WiFi key. Keeping track of the WiFi key may be even more difficult if, for security reasons, the WiFi key is periodically changed. Because of this record keeping problem, users are hesitant to change the WiFi key as recommended for security reasons. As a consequence, the WiFi network is more vulnerable to a remote attacker of the network.

### SUMMARY OF THE INVENTION

Accordingly, in some implementations a set of self-configuring secure wireless network devices are provided that automatically establish a secure wireless network when powered up.

In some implementations, a secure wireless network is provided that easily accommodates the addition of new wireless enabled devices lacking user interfaces to an established secure wireless network.

In some implementations, a secure wireless network is provided that does not require an end user to have knowledge of its wireless key to add new wireless enabled devices to the network.

In some implementations, a system is provided that includes a secure wireless network that automatically updates its wireless key periodically to enhance system security.

In general, one innovative aspect of the subject matter described in this specification can be embodied in self-configuring wireless systems that include one or more wireless network devices; a primary access point device; and a secondary access point device; wherein the primary access point device and the at least one wireless network device are preconfigured with a respective key so as to enable the primary access point device to establish a secure wireless network with the at least one network device using the respective keys, and wherein the secondary access point device is configured assume coordination for the self-configuring wireless system if a fault associated with the primary access point device occurs.

The foregoing and other embodiments can each optionally include one or more of the following features, alone or in combination. The fault associated with the primary access point device is a loss of network connectivity to a remote service provider system. The fault associated with the primary access point device is a failure of the primary access point device. Assuming coordination includes receiving a signal from the primary access point device switching control of the system. Assuming coordination includes transmitting, by the secondary access point device, a mastership signal to each of the one or more wireless network devices. The secondary access point device is configured to return coordination to the primary access point device if the fault resolved. The primary access point device is configured to automatically establish communication with a remote service provider system. The secondary access point device is further configure to establish communication with the remote service provider system in response to providing coordination for the self-configuring wireless system. The secondary access point device uses a distinct form of network communication from the primary access point device, and wherein the form of network communication includes one or more of a public switched telephone network (PSTN), 3G, LTE, GSM, or CDMA. The access point device is configured to update the at least one wireless network device with a first new key, and re-establish the wireless network using the first new key. The first new key is received from a remote service provider device, the first new key uniquely identifying a user and derived using one or more unique user identifiers, the user identifiers including one or more of a user telephone number, address, email address, social security number, driver's license number, or credit card number. The access point device is configured to generate the first new key using a unique identifier of the access point device.

In general, one innovative aspect of the subject matter described in this specification can be embodied in self-configuring wireless systems that include multiple wireless network devices; and an access point device; wherein the access point device and the at least one wireless network device are preconfigured with a respective key so as to enable the access point device to establish a secure wireless network with the at least one network device using the respective keys, and wherein one wireless network device of the multiple network devices includes a secondary coordinator configured assume coordination for the self-configuring wireless system if a fault associated with the access point device occurs.

The foregoing and other embodiments can each optionally include one or more of the following features, alone or in combination. The fault associated with the primary access point device is a loss of network connectivity to a remote service provider system. The fault associated with the primary access point device is a failure of the primary access point device. Assuming coordination includes receiving a signal from the primary access point device switching control of the system. Assuming coordination includes transmitting, by the secondary access point device, a mastership signal to each of the one or more wireless network devices. The secondary access point device is configured to return coordination to the primary access point device if the fault resolved.

In general, one innovative aspect of the subject matter described in this specification can be embodied in methods that include the actions of establishing a self-configured wireless network among a primary access point device and one or more wireless enabled devices; periodically transmitting a mastership signal to each of the one or more wireless enabled devices indicating that the primary access point device is a primary coordinator for the self-configured wireless network; determining that one or more transfer criteria has occurred; and transferring coordination of the self-configured wireless network to a secondary coordinator.

The foregoing and other embodiments can each optionally include one or more of the following features, alone or in combination. Determining that the transfer criteria has occurred includes determining that a network connection between the primary coordinator and a remote service provider system has failed. The method further includes periodically transmitting, by the primary coordinator, a wellness signal to each of the one or more wireless enable devices. Determining that the transfer criteria has occurred includes determining that the healthiness signal has not been received for a specified period of time. Determining that the transfer criteria has occurred includes determining that the mastership signal has not been received for a specified period of time. The method further includes resolving a fault condition associated with the transfer criteria, and restoring coordination of the self-configured wireless network to the primary coordinator.

Additional implementations, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 illustrates a block diagram of a conventional secure WiFi network.

FIG. 2 illustrates a block diagram of wired-connections conventionally used for adding a WiFi enabled camera to a secure WiFi network.

FIG. 3 illustrates a schematic diagram depicting an example of how self-configuring secure wireless network devices are generated by a product provider and provided to an end user using a method utilizing aspects of the present invention.

FIG. 4 illustrates a schematic diagram depicting example actions performed by different entities for making, distributing, installing, and maintaining a self-configuring secure wireless network utilizing aspects of the present invention.

FIG. 5 illustrates a block diagram of an example system including a self-configuring secure wireless network with AP device as router, utilizing aspects of the present invention.

FIG. 6 illustrates a block diagram of an example system including a self-configuring secure wireless network with AP device configured as a router or a bridge behind another router, utilizing aspects of the present invention.

FIG. 7 illustrates an example series of actions performed by an access point device in a secure wireless network included in a system utilizing aspects of the present invention.

FIG. 8 illustrates an example series of actions performed by a service provider service during self-activation by an access point device in a system utilizing aspects of the present invention.

FIG. 9 illustrates an example series of actions performed by a mobile device to activate an access point device of a secure wireless network included in a system utilizing aspects of the present invention.

FIG. 10 illustrates an example series of actions performed by either a service provider server or an access point device to generate a new key for a secure wireless network included in a system utilizing aspects of the present invention.

FIG. 11 illustrates an example series of actions performed by an access point device to install a new key for a secure wireless network included in a system utilizing aspects of the present invention.

FIG. 12 illustrates an example series of actions performed by an access point device in response to a data request from a service provider server in a system utilizing aspects of the present invention.

FIG. 13 illustrates an example series of actions performed by a mobile device to add a new wireless enabled device to an established secure wireless network included in a system utilizing aspects of the present invention.

FIG. 14 illustrates an example series of actions performed by a service provider server in response to a request to add a new wireless enabled device to an established secure wireless network in a system utilizing aspects of the present invention.

FIG. 15 illustrates an example series of actions performed by an access point device to add a new wireless enabled device to an established secure wireless network in a system utilizing aspects of the present invention.

FIG. 16 illustrates a block diagram of an example system including a self-configuring secure wireless network including one or more network extenders, utilizing aspects of the present invention.

FIG. 17 illustrates a block diagram of an example system including a backup access point device.

FIG. 18 illustrates a block diagram of an example system including an IP device configured to act as a backup access point device.

FIG. 19 is a flow diagram of an example process for redundant coordinator support.

FIG. 20 is a flow diagram of an example process for redundant coordinator support.

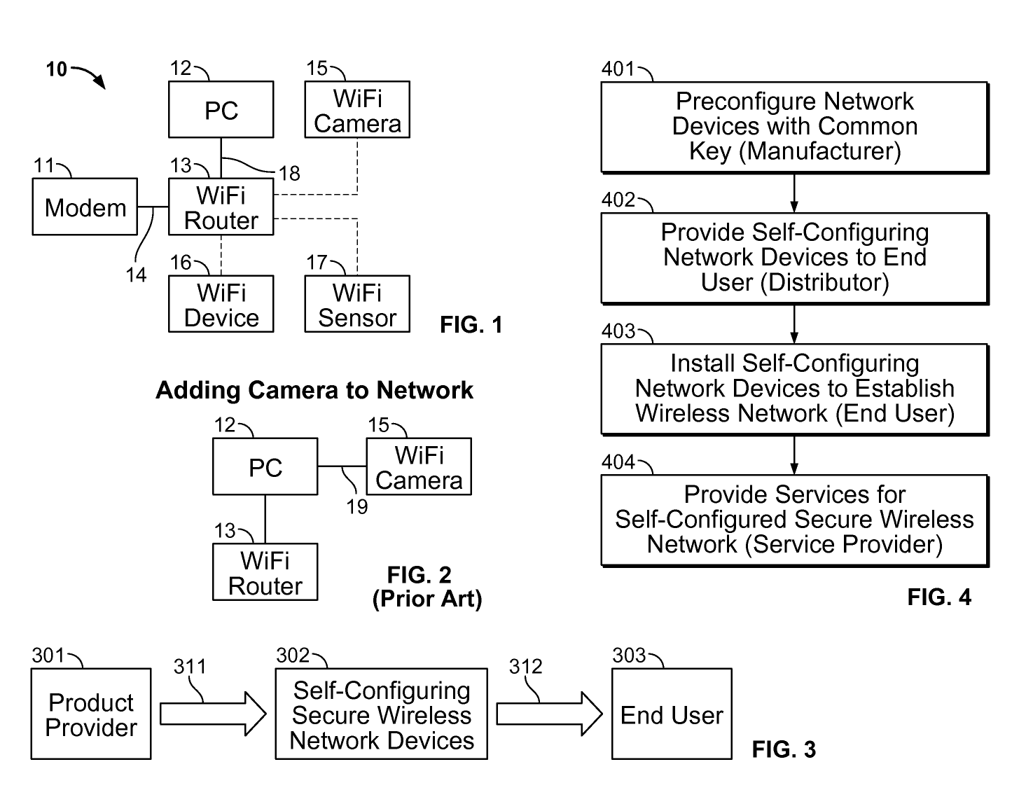

### DETAILED DESCRIPTION

Although a home security system is used as an example in this detailed description, it is to be appreciated that the various aspects of the present invention are not to be limited to such a system and are generally applicable to any type of secure wireless network in which wireless enabled devices to be added to the network lack user interfaces for a user to enter a wireless key during the device installation process. Other examples of networks in which wireless enabled devices lack user interfaces may include extra-home security networks, e.g. an automobile security network, office security network, or storage facility security network, office networks, hospital or clinic networks, or classroom networks.

Initial set up of a secure wireless network is especially cumbersome when many of the wireless enabled devices to be included in the network lack user interfaces for entering a wireless key during the device installation process. As an example, a home surveillance system may include many wireless enabled cameras and numerous wireless enabled sensors that lack user interfaces to facilitate their addition to the home network.

To vastly simplify the end user's task of setting up a secure wireless network, a self-configuring secure wireless network is described herein that automatically establishes the secure wireless network upon power-up with little or no user interaction. To facilitate such a plug-and-play resembling feature, an access point device and one or more wireless enabled devices to be included in the secure wireless network, are preprogrammed with a common Service Set Identifier (SSID) and common key that is used for establishing the secure wireless network. The common key may be a unique key which is associated with a user of the secure wireless network. Alternatively, the common key may be a default key that is the same for all access point devices and wireless enabled devices manufactured or distributed by a common source. Since the common SSID and common key are preprogrammed into the access point device and the wireless enabled devices, the access point device can automatically establish the secure wireless network upon power-up without further intervention by, and transparently to, the user.

As an example of a common key which is uniquely associated with a user, the common key may be derived from a number uniquely identifying the user such as a phone number, email address, postal address, social security number, driver's license number, credit card number, etc. For security reasons, the common key may be generated using a pseudo-random number generator or other encryption algorithm. A number uniquely identifying the user may be provided as a seed to the generator. The resulting key may be generated as a WEP or WPA key. A record of the common key generated in this manner may then be kept for each user by the manufacturer and/or distributor of the self-configuring secure wireless network and provided to the user along with the self-configuring secure wireless network.

A software agent is provided in the access point device so that its controller automatically establishes a connection with a remote server when the access point device is connected to an Internet gateway and powered up. When the remote server is a service provider server, it is to be appreciated that the service provider server may also be connected to many other access point devices and their corresponding secure wireless networks, such as in the case of a home security service being connected to the many home security systems of its subscribers. The remote server may then request the controller to perform numerous tasks including updating the wireless key from the common key to a new key or from the new key to a newer key, transmitting data from wireless enabled network devices to authorized devices requesting such data, and adding new wireless enabled network devices to an established secure wireless network. Each key can be distinct from each other key. The access point device may be configured as an intelligent router or bridge. In addition to the controller, the access point device includes memory for storing information such as the common key, program code for the software agent, and other items described herein.

The access point device includes interface logic, such as a transmitter and receiver, for communicating with the wireless devices on the secure wireless network. The interface logic may be integrated into the access point device or attached to it in the form of a dongle. Supported wireless technologies include WiFi, Bluetooth, Z-Wave, ZigBee, 433 MHz RF, and other Radio Frequency (RF) technologies. Although the current examples described herein may refer to WiFi devices, it is to be appreciated that various aspects of the present invention are also applicable to other RF technologies as well. Further, the access point devices described herein may communicate with multiple wireless technologies in a given configuration. In such cases, a single common key used for all RF technologies may be used or a different common key for each RF technology may be used. A data packaging module may also be included in the access point device to packetize and transmit data received from devices operating under different wireless technologies to the remote server.

FIG. 3 illustrates, as an example, a schematic diagram of self-configuring secure wireless network devices 302 being generated by a product provider 301 using a process 311 (as described elsewhere herein) and being provided to an end user 303 through a distribution channel 312. In this example, the product provider may be either the manufacturer of the wireless enabled network devices, a Value Added Reseller (VAR), or a distributor of the wireless enabled network devices.

FIG. 4 illustrates, a schematic diagram depicting example actions performed by different entities for making, distributing, installing, and servicing a self-configuring wireless network. In particular, in block 401, a manufacturer or VAR preconfigures the network devices with a common key (as described elsewhere herein). In block 402, a distributor provides the self-configuring network devices to an end user. The distributor may be a party that buys, or takes on consignment, the self-configuring network devices to sale them to end users. Alternatively, the distributor may be the manufacturer or the VAR, who in this case, commercially distributes the self-configuring network devices directly to end users. In block 403, the end user installs the self-configuring network devices (as described elsewhere herein) to establish a secure wireless network at the end user's site. In block 404, a service provider provides various services related to the established secure wireless network (as described elsewhere herein).

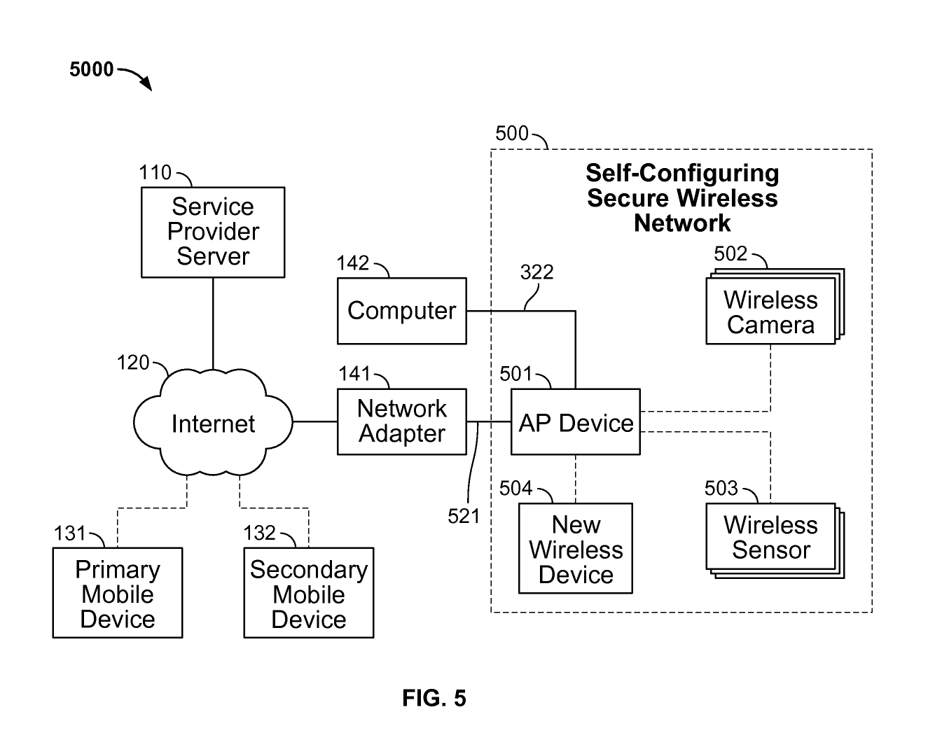

FIGS. 5-15 provide additional details on the self-configuring secure wireless network and its use within a home security system. Resources in the home security system may be accessed and managed through a server of a service provider by the user and other authorized parties using pre-authorized devices such as laptop computers, desktop computers, tablet computers, and mobile phones. Access may also be provided through any Internet connected device which may become an authorized device using a conventional user name and password procedure with the service provider server.

FIG. 5 illustrates an example block diagram of a system 5000 including a self-configuring secure wireless network 500, which is connected through the Internet 120 to a service provider server 110. The self-configuring secure wireless network 500 includes an Access Point (AP) device 501 and wireless enabled devices 502, 503 which have been preprogrammed with a common key so that upon powering up the devices, the AP device 501 establishes a secure wireless network using the common key. “Preprogrammed” in this sense means the common key has been retrievably stored in a memory of the device.

In a typical home security system, several strategically positioned cameras 502 and sensors 503 may be included. In addition to sensors included for security purposes such as movement and displacement sensors, for example, detecting the opening of doors and windows, other sensors providing other useful information may be included such as doorbell sensors, smoke detector alarm sensors, temperature sensors, and/or environmental control sensors and/or controls. An additional wireless device 504 is also shown, which has been subsequently added to the secure wireless network 500 after the installation of the secure wireless network 500 in the home security system. Hence, it is referred to as being a “new” wireless device. Similar to the wireless enabled devices 502, 503, the new wireless device 504 has also been preprogrammed with the common key so that it too can provide for self-configuration of the secure wireless network 500.

In this example, the Access Point (AP) device 501 is the only router in the home security system. Therefore, all devices that are to be networked must be connected to the AP device 501. To this end, the AP device 501 preferably includes at least one of an Ethernet receptacle or Universal Serial Bus (USB) receptacle so that various devices such as computer 142 may be wire-connected to it, such as through an Ethernet connection 522. The AP device 501 in this case is configured to be in “router” mode. Hence, it is referred to as being a router access point device.

The AP device 501 is wire-connected, such as through an Ethernet connection 521, to a network adapter 141, e.g., a modem or directly to the Internet through an ISP. Preferably, a broadband connection is used for high speed transmission of video data from the wireless camera 502 and sensor data from the wireless sensor 503. The AP device 501 includes a Dynamic Host Configuration Protocol (DHCP) server which is enabled in this case so that it may assign IP subaddresses to devices connecting through the AP device 501 to the Internet 120.

As previously explained, the AP device 501 has a software agent residing in it that automatically establishes a connection with a remote service provider server 110 upon the AP device 501 being powered up and after it has been connected to the Internet 120 through the modem 141, which serves as an Internet gateway. The service provider server 110 interacts with the AP device 501 and authorized devices, such as primary and secondary mobile devices 131, 132, to perform various functions and/or services as described herein.

The mobile devices 131, 132 preferably also have software agents or resident applications for such interaction with the service provider server 110. Devices that are attempting to interact with the service provider server 110 may confirm their authority to the service provider server 110, for example by providing information that uniquely identifies the requesting device, such as an Internet Protocol (IP) address, a product serial number, or a cell phone number. Alternatively, they may provide a user name and password which are authorized to interact with the self-configuring secure wireless network 500. To facilitate such authorization procedures, the service provider server 110 stores or has ready access to such authorization information for each self-configuring secure wireless network of users who subscribe to the service.

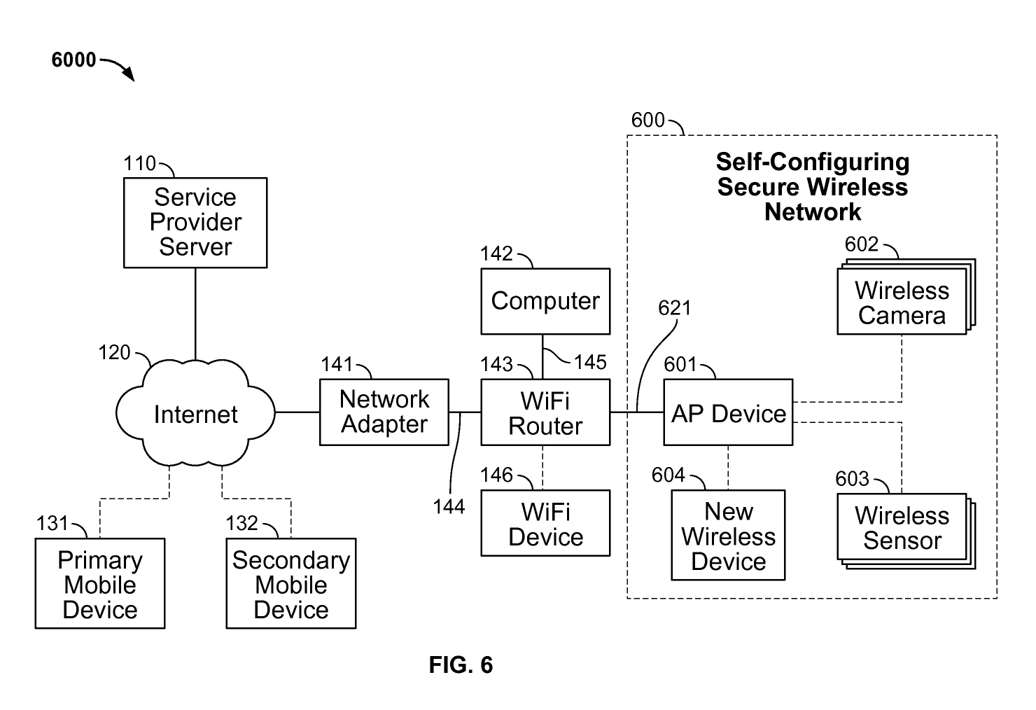

FIG. 6 illustrates, as an example, a block diagram of a system 6000 including a self-configuring secure wireless network 600 that is connected in an alternative manner through the Internet 120 to the service provider server 110. In this case, the AP device 401 is wire-connected to a WiFi router 143 through an Ethernet connection 621 so that the AP device 601 is only indirectly connected to the modem 141, which is connected to the WiFi router 143 through another Ethernet connection 144. The AP device 601 may be configured as either a router access point device or a bridge access point device. The following describes the AP device 601 when configured as a bridge access point device.

When the AP device 601 is configured as a bridge access point device, the Access Point mode for the AP device 601 is enabled. Under this configuration, only one subnetwork is present. Also, all devices in the self-configuring secure wireless network 600 are preprogrammed with a common SSID and common key, such as in the case of the self-configuring secure wireless network 500. However, since the WiFi router 143 has a DHCP server, the DHCP server of the AP device 601 is disabled so that the DHCP server of the WiFi router 143 may assign private IP addresses to all devices connecting through the AP device 601 to the WiFi router 143. The AP device 601 may be configured, e.g., by a seller or manufacturer, to allow its Internet Protocol (IP) address to be dynamically assigned by DHCP server of the WiFi router 143 or it may be configured with a statically assigned IP address.

When the AP device 601 is configured as a router access point device, two subnetworks are present. A first subnetwork is the WiFi network established by the WiFi router 143, which includes a WiFi device 146. A computer 142 is wire-connected to the WiFi router 143 using an Ethernet connection 145. A second subnetwork is the secure wireless network established by the AP device 601 which includes wireless enabled devices 602-604. In this case, the DHCP server of the AP device 601 is enabled. The first subnetwork in this case has a different SSID and different key than the second subnetwork. The SSID of the second subnetwork is preprogrammed along with the common key into all devices of the self-configuring secure wireless network 600. For security purposes, the SSID of the second subnetwork is preferably not broadcasted by the AP device 601. Wireless enabled devices 602-604 are configured to only connect to the SSID of the AP device 601. Therefore, they do not need to detect which networks are available to be connected to.

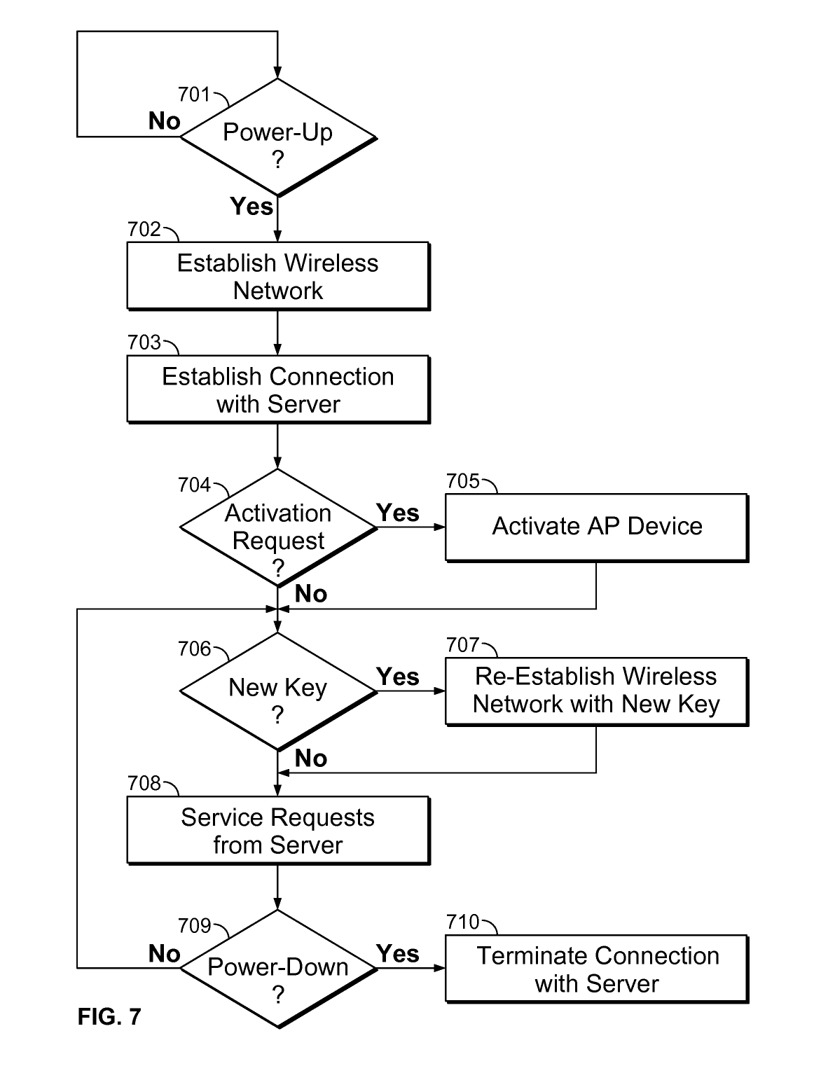

FIG. 7 illustrates an example series of actions performed by an AP device (such AP devices 501, 601) in a secure wireless network included in a home security or other system. In block 701, the AP device detects whether it has been powered up using, for example, a power-up detection circuit. Upon being powered up, in block 702, the AP device executes stored program instructions to establish a secure wireless network using either a common key, which has been preprogrammed into the AP device and all other devices as part of a self-configuring wireless network (such as networks 500, 600), or a subsequently provided key which has been stored in a memory of the AP device. In block 703, the AP device then establishes a secure connection with a remote service provider server (such as server 110) through an Internet gateway connected at the time to the AP device. To facilitate such connection, an IP or URL address of the service provider server is programmed into the software agent running on the AP device. To make the transmission secure, the transmission may be encrypted in a conventional manner such as using a public/private key exchange.

In block 704, after establishing a secure Internet connection with the service provider server, the AP device determines whether an activation request has been received from the service provider server. The service provider server issues the activation request if the AP device has not been previously activated with the service provider server. If the determination in block 704 is YES, then in block 705, the AP device performs a self-activation procedure by retrieving and sending its unique product serial number to the service provider server. The service provider server then processes the serial number to activate the AP device.

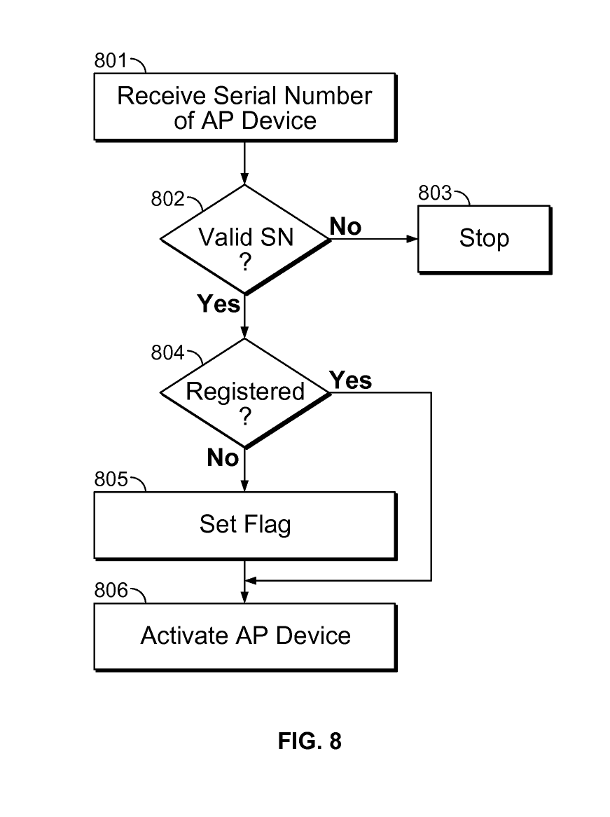

FIG. 8 illustrates an example series of actions performed by the service provider server to activate the AP device. In block 801, the server receives the serial number from the AP device. In block 802, a determination is made whether the serial number is valid. If the determination in block 802 is NO, then in block 803, the process stops without activation of the AP device. If the determination in block 802 is YES, then in block 804, a determination is made whether the AP device is currently registered with the service provider server. Registration in this case means a database record for the AP device has already been created by the service provider server. If the determination in block 804 is YES, then in block 806, the service provider server activates the AP device by setting a flag in the record which indicates that the previously registered AP device is now activated. On the other hand, if the determination in block 804 is NO, then in block 805, a database record for the AP device is created by including the serial number of the AP device and setting another flag indicating additional registration information is necessary. In block 806, the service provider server activates the AP device as previously described.

Although a self-activation procedure is described above for block 705, the activation and registration of the AP device may instead be initiated and managed using a mobile device such as a smartphone or other authorized device. In this case, a software application is first installed on the mobile device or other authorized device.

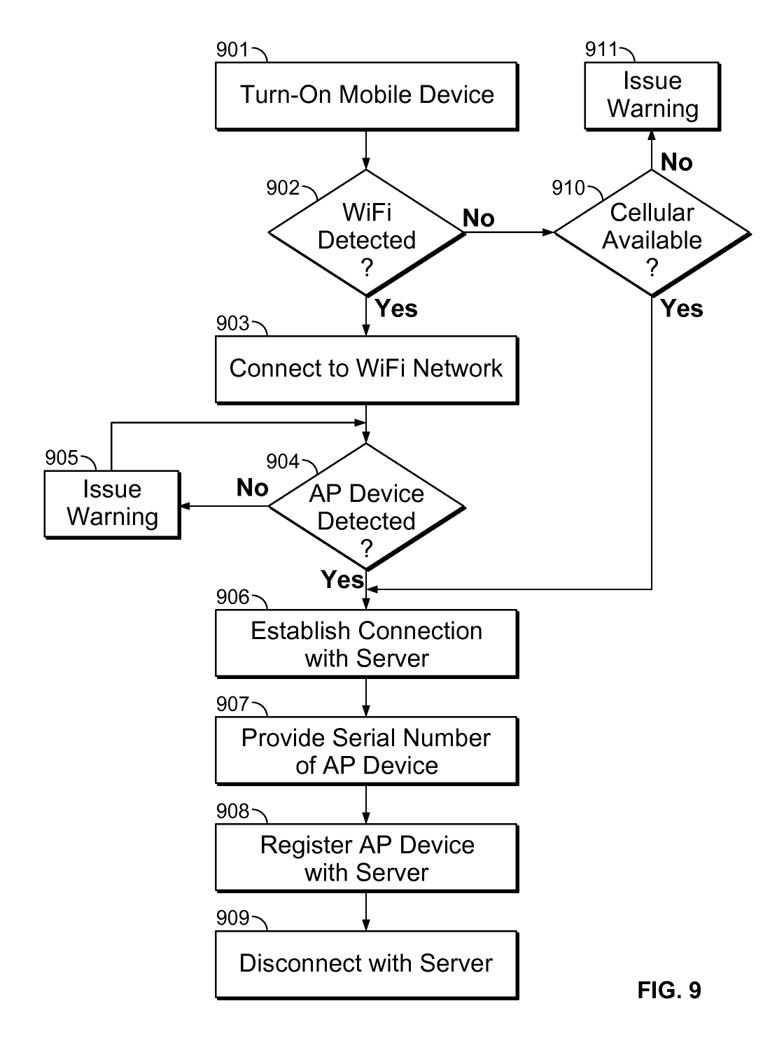

FIG. 9 illustrates an example series of actions performed by a mobile device to activate the AP device. In block 901, the user turns on the mobile device and in block 902, the mobile device makes a determination of whether the home WiFi network is available for connection. If the determination in block 902 is YES, then the mobile device connects to the home WiFi network in a conventional manner using the password for the home network. An example of such connection is the WiFi device 146 connecting to the WiFi router 143 in FIG. 6. After connecting to the home network, in block 904, the mobile device makes a determination of whether the AP device is detected on the network. If the determination in block 904 is NO, then in block 905, a warning message is issued on a screen of the mobile device to make sure the AP device is wire connected to the home router and turned on. The process then continues to loop through block 904 until a YES determination is made or the software application is terminated by a user of the mobile device.

Once the mobile device detects the AP device is connected to the home network, then in block 906, the mobile device establishes a connection with the service provider server. In block 907, the mobile device provides the serial number of the AP device to the service provider server. The mobile device may do so by its user typing in the serial number or its user using a bar code scanner application to scan in the serial number, for example, from a bar code on the AP device or its packaging. In block 908, the user of the mobile device may then provide registration information to the service provider server such as the user's contact information, e.g., the user's postal address, phone number, and email address, a user name and password, phone numbers of smartphones authorized to access the resources of the secure wireless network through the service provider server, and/or other information identifying and/or defining the authority of a primary and optionally other users of the secure wireless network. As previously explained, the authorized smartphones can be treated as authorized devices when subsequently attempting to access resources of the secure wireless network through the service provider server and the AP device. Other devices may gain such access by their users providing the user name and password.

After completion of the activation and registration of the AP device, the mobile device may terminate its connection with the service provider server in block 909 by, for example, exiting the software application. Control may then be passed back to the AP device to perform block 706 of FIG. 7.

If the determination in block 902 is NO, i.e., the mobile device is unable to connect to the home WiFi network, then in block 910, the mobile device attempts to establish an Internet connection with the service provider server through a cellular telephone service usable by the mobile device (e.g., a 3G or 4G service). If no cellular telephone service is available to the mobile device, then in block 911, an error message is displayed on a screen of the mobile device. On the other hand, if a cellular telephone service is available to the mobile device, then the mobile device performs blocks 906-909 as previously described by using the cellular telephone service instead of the WiFi connection.

As an alternative to using a mobile device for activation and registration of the AP device, a computer connected to the home WiFi network, such as computer 142 in FIGS. 5 and 6, may be used. In this case, a software application is first installed on the computer so that the computer may perform tasks described in reference to blocks 904-909 of FIG. 9 instead of the mobile device.

Referring back to FIG. 7, if the determination in block 704 is NO, then in block 706, the AP device determines whether a new key has either been received from the remote service provider server or is to be generated by the AP device. As previously explained, periodically changing the password or WiFi key for the secure WiFi network is desirable for security reasons. In addition, the common SSID preprogrammed into the AP device may also be periodically changed for security purposes. In this case, the new SSID is shared by the AP device with connected wireless enabled devices in the same manner as the new key so that the secure wireless network may be re-established with the new SSID and new key. Accordingly, wherever updating of the wireless key with a new key is described or claimed herein, it is to be appreciated that optionally updating of the SSID may also be performed in generally the same manner including deriving the new SSID from information uniquely identifying the user or the AP device.

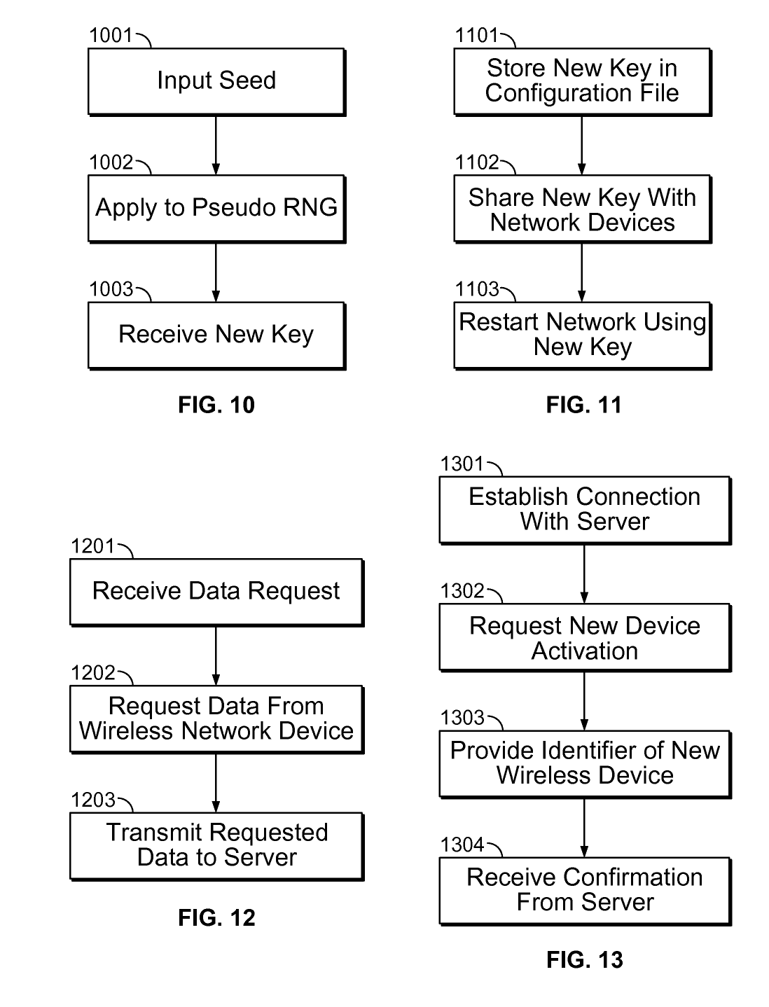

FIG. 10 illustrates an example series of actions performed by either the service provider server or the AP device to generate a new key for the secure wireless network. In block 1001, a seed is provided to a unique key generator such as a pseudo-Random Number Generator (pseudo-RNG). When the new key is being generated by the service provider server, the seed may be derived from any unique customer identification number from information provided, for example, during the registration process.

When the new key is being generated by the AP device, the seed may be derived from its serial number. The seed may be modified in some manner each time a new key is generated, for example, by logically combining the seed with the date or time stamp so that a different seed is used and a different new key is generated. In block 1002, the seed is applied to the pseudo-random number generator. In block 1003, the generated new key is received as output of the pseudo-random number generator. The new key may be a WEP key or WPA key, depending upon the desired level of security for the secure wireless network. When the new key is generated by the service provider server, it may optionally be stored in the database record previously created for the AP device along with a time stamp indicating when the new key was generated.

Referring back to FIG. 7, if the determination in block 706 is YES, then in block 707, the AP device shares the new key with all devices on the secure wireless network and re-establishes the secure wireless network using the new key.

FIG. 11 illustrates, as an example, tasks performed by the AP device in block 707 to install the new key for the secure wireless network. In block 1101, the AP device stores the new key in a configuration file or other designated location in its memory. If this is the first time a new key has been provided to the AP device, then the AP device may first create the configuration file. Thus, if no configuration file is found on the AP device, then the AP device will establish the secure wireless network using the original common key programmed or otherwise stored on the AP device. In block 1102, the AP device shares the new key with all other WiFi enabled network devices on its secure wireless network. In block 1103, the AP device then restarts the secure wireless network using the new key.

Again referring back to FIG. 7, if the determination in block 706 is NO, then the AP device continually checks to see if a new key is received in block 706 and services any requests received from the remote service provider server in block 708 until a determination is made that the AP device is powered down in block 709. Examples of requests that the AP device may receive from the remote service provider server are described in reference to FIGS. 12-15 as follows. If a power down indication is received by the AP device as determined in block 709, then in block 710, the AP device terminates the connection with the remote service provider server before turning off the secure wireless network.

FIG. 12 illustrates an example series of actions performed by an AP device in response to a data request from a service provider server in a home security system. In particular, in block 1201, the AP device receives a data request from the service provider server. In block 1202, the AP device routes the data request to the appropriate device (from which the data is being requested) on the secure wireless network. In block 1203, the AP device receives the requested data from the device and transmits the requested data to the service provider server.

The data request may be initiated by either the service provider server, e.g., server 110 in FIGS. 5 and 6, according to a programmed schedule or it may be initiated by an authorized device, e.g., such as mobile devices 131, 132 in FIGS. 5 and 6, or authorized user interacting with the service provider server. As an example of a data request initiated by the service provider server, surveillance video may be periodically requested from one or more of the wireless enabled cameras, such as cameras 502, 602 of FIGS. 5 and 6, and stored in cloud or local storage for later viewing by an authorized user. As another example of a data request initiated by the service provider server, sensor data may be periodically requested from one or more of the wireless enabled sensors, such as sensor 303 of FIGS. 5 and 6, and stored in cloud or local storage as raw data or the sensor data may be processed and stored in cloud or local storage as processed data.

As an example of a data request initiated by an authorized device or user, surveillance video or sensor data from a network device specified by the authorized device may be requested by a user interacting with the service provider server through the authorized device. The request in this case may result from the initiative of the user or it may result from a sensor warning or other indication received by the authorized device through the service provider server. As an example, a doorbell sensor, movement sensor, or displacement sensor, e.g., a sensor which detects a door or window being opened, may initiate a warning that is transmitted to a specified mobile device, such as specified by the cell phone number of the primary end user, through the AP device and service provider server. A video feed or captured still image from the closest surveillance camera on the secure wireless network may then be requested by the user and transmitted to the authorized device. Alternatively, the video feed or captured still image from the closest surveillance camera may be automatically transmitted along with the warning. Additionally, the user of the authorized device may also make a request for such data at any time without prodding from a sensor device.

Although mobile devices are generally described herein as data requesters or device activators, they may also be configured as data providers for the system. For example, application software residing on a mobile device may provide the capability for its camera to serve as an IP camera so that other authorized devices in the system may receive captured pictures or video from the mobile device. As an example of this, a smartphone, such as the primary mobile device 131, which is equipped with such software, can provide captured images and video to authorized devices through the service provider server. Sensor information from mobile devices may also be shared in a similar manner. In this way, the surveillance area may be extended well beyond typical WiFi or other RF technology ranges.

FIGS. 13-15 illustrate, as an example, tasks performed respectively by an authorized device, the service provider server, and the AP device to add a new wireless enabled device to an established wireless connection. In this example, the new wireless enabled device is a WiFi enabled device which has been preprogrammed with the same common key that the AP device and all other wireless enabled devices were preprogrammed with by their manufacturer or distributor. Examples of such a device is the new wireless device 504 of FIG. 5 and the new wireless device 604 of FIG. 6, which are to be respectively connected to the secure wireless networks established by AP devices 501 and 601. Since the new wireless devices 504 and 604 have been preprogrammed with the common SSIDs and common keys of their respective AP devices 501 and 601, they are shown in FIGS. 5 and 6 as being included as part of the self-configuring secure wireless networks 500 and 600, respectively, even though they were not part of the initial installation of the self-configuring secure wireless networks 500 and 600. Also, in this example, the authorized device is a mobile device, such as a smartphone. However, it is to be appreciated that any authorized device capable of establishing an Internet connection with the service provider server may be alternatively used.

FIG. 13 illustrates an example series of actions performed by a mobile device operated by a user to add a new WiFi enabled device to the secure wireless network. In block 1301, the mobile device establishes a connection with the service provider server through the Internet either through the home WiFi network as described in reference to blocks 902, 903, and 906 of FIG. 9 or using a wireless communication network such as 3G or 4G as described in reference to blocks 910 and 912 of FIG. 9. In block 1302, the mobile device requests activation of a new wireless device to the service provider server. In block 1303, the mobile device provides the unique identifier such as a serial number of the new wireless device to the service provider server in the same manner as it provides the unique identifier of the AP device as described in reference to block 907 of FIG. 9. In block 1304, the mobile device receives confirmation from the service provider server after the new wireless device has been successfully activated.

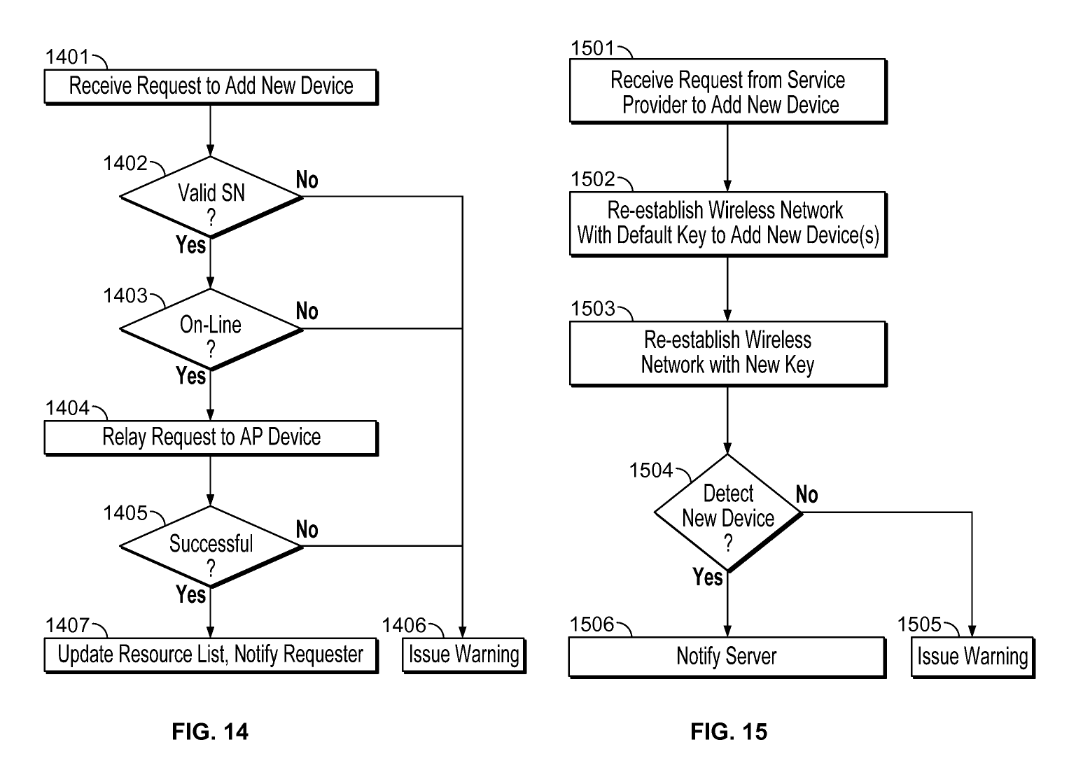

FIG. 14 illustrates an example series of actions performed by a service provider server such as server 110 in FIGS. 5 and 6. In block 1401, the service provider server receives a request from an authorized device, such as mobile devices 131, 132 of FIGS. 5 and 6, to add a new wireless enabled device to an established secure wireless network, which the authorized device is authorized to request data from and/or control resources of Prior to making such request, however, the new wireless device should be powered on and physically located within operating distance to the AP device of the secure wireless network.

In block 1402, the service provider server makes a determination whether or not the new wireless device may be added to the secure wireless network. To do this, the service provider server requests, if it hasn't already been provided, the device's unique identifier and confirms its validity as a proper serial number. If the determination in block 1402 is NO, the service provider server sends a warning message back to the authorized device to notify its user that the device cannot be added.

On the other hand, if the determination in block 1402 is YES, then in block 1403, the service provider server next determines whether the associated AP device, i.e., the AP device to which the new wireless device is to be wirelessly connected to, is on-line at the time, i.e., a connection currently exists between the AP device and the service provider server. If the determination in block 1403 is NO, then the service provider server sends a warning message back to the authorized device to make sure the AP device is connected to an Internet gateway and is powered up.

If the determination in block 1403 is YES, then in block 1404, the request to add the new wireless device to the established secure wireless network is relayed to the AP device. In block 1405, the service provider server periodically checks whether the AP device has successfully added the new wireless device to its secure wireless network. If the determination in block 1405 is still NO after a specified period of time, in block 1406, the service provider server sends a warning message back to the authorized device to notify its user that the request to add the new wireless device has failed. The warning message may also provide a recommendation that the user make sure that the new wireless device is powered on and within operating distance to the AP device before trying again to add the new wireless device in another request to do so.

If the determination in block 1405 is YES within the specified period of time, the service provider server then adds information of the newly added wireless device to a list of resources available on the secure wireless network and notifies the requesting authorized device that a successful addition of the new wireless device to the secure wireless network has been completed.

FIG. 15 illustrates an example series of actions performed by the AP device to add a new wireless enabled device to an established secure wireless network in a home security system. In this example, it is assumed that the secure wireless network has been previously established using a new key, not using the preprogrammed common key.

In block 1501, the AP device receives the request to add the new wireless enabled device from the service provider server. Since the new wireless enabled device has been confirmed by the service provider server as being valid, the new wireless device may be presumed to have been pre-programmed with the same common key that was provided in the AP device's self-configuring secure wireless network. In this example, the common key is the default key to simplify the description.

In block 1502, the AP device then re-establishes the secure wireless network using the common key, which has been permanently stored in memories of the network devices. Since the new wireless enabled device has also been preprogramed with the common key, it is now added to the re-established secure wireless network. In block 1503, the AP device then shares the new key, which it has stored in its memory, with all devices on the secure wireless network, including the new wireless enabled device, then re-establishes the secure wireless network using the new key. In block 1504, the AP device then determines whether the new wireless device has been connected to the re-established secure wireless network. If the determination in block 1504 is NO, then in block 1505, the AP device sends a warning message back to the service provider server, which in turn, may relay the warning message back to a requesting authorized device, e.g., a mobile device operated by a user. If the determination in block 1504 is YES, then in block 1506, the AP device sends a success message back to the service provider server, which in turn, may relay the success message back to the requesting authorized device.

As an alternative to the above described method for activating a new wireless device, if the user desires to connect the new wireless device without going through the service provider server, the user may simply press reset buttons on the AP device and all wireless enabled network devices currently connected to the AP device so that their current keys are either erased or otherwise preempted by the preprogrammed common key. The user may then power down all devices, then power back up all wireless enabled network devices to be connected to the AP device, and finally power back up the AP device so that it may re-establish the secure wireless network using the common key originally programmed in all the devices. In this way, the new wireless device is included along with the wireless enabled devices previously connected to the AP device.

Alternatively, rather than performing a power down/up cycle, the depressing of the reset buttons may automatically power down and power back up their respective devices after the devices have reset the wireless network key back to the preprogrammed common key. A software agent installed on the AP device at the time of its initial configuration may then cause the AP device to identify the newly added wireless device (along with all other wireless enabled devices that have reset their respective wireless network keys as described above), retrieve the unique identifier from the newly added wireless device, and transmit the retrieved unique identifier to the service provider server to activate the new wireless device in a manner as previously described. After successful activation of the newly added wireless device, the service provider server may then command the AP device to re-establish the secure wireless network using the previously preempted new key or a different new key, which may be generated by either the service provider server or the AP device as previously described.

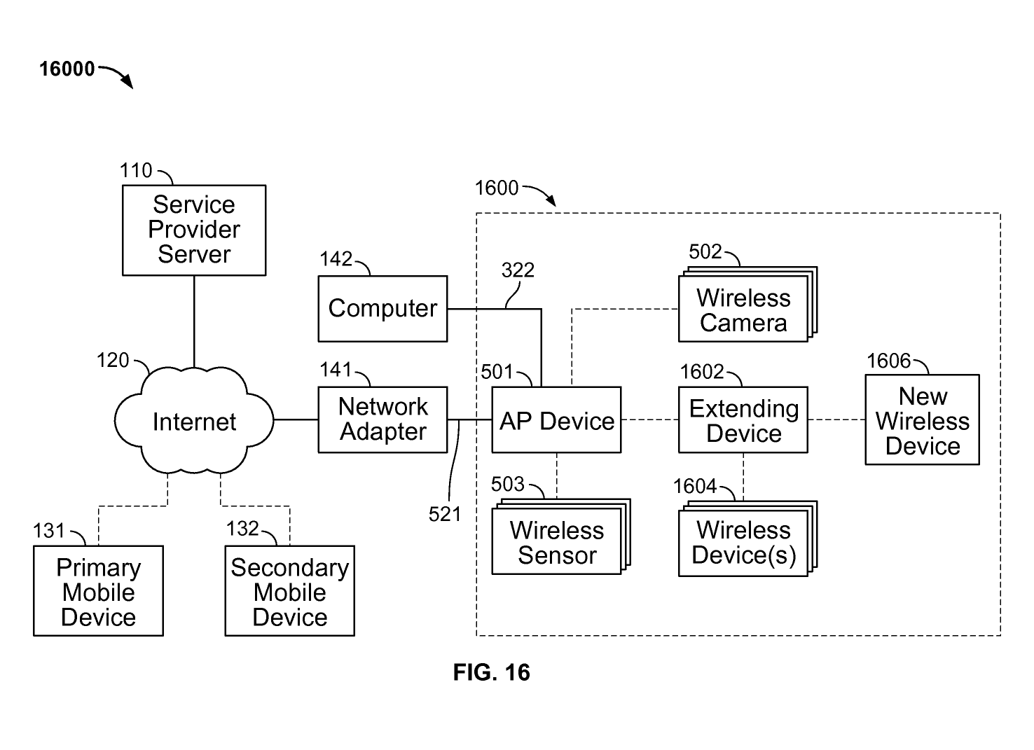

FIG. 16 illustrates a block diagram of an example system 16000 including a self-configuring secure wireless network 1600 including a network extender 1602. The self-configuring secure wireless network 1600 is connected through the internet 120 to a service provider server 110. The self-configuring secure wireless network 1600 includes an Access Point (AP) device 501 and wireless enabled devices 502, 503, which have been preprogrammed with a common key so that upon powering up the devices, the AP device 501 establishes a secure wireless network using the common key as described above.

In a typical home security system, several strategically positioned cameras 502 and sensors 503 may be included. In addition to sensors included for security purposes such as movement and displacement sensors, for example, detecting the opening of doors and windows, other sensors providing other useful information may be included such as doorbell sensors, smoke detector alarm sensors, temperature sensors, and/or environmental control sensors and/or controls.

However, the AP device 501 has a limited range. As a result, one or more wireless enabled devices may not be within range of the AP device 501. At least one extending device 1602 can be used to extend the range of the secure wireless network 1600 such that additional wireless enabled devices can be added. The extending device 1602 can be wireless bridge or repeater device. The wireless bridge is used to connect two or more network segments that are physically and/or logically separated. The extending device 1602 can be, for example, a wireless router or wireless access points that offers either a “bridge” mode or a “repeater” mode. The extending device 1602 can be preprogrammed with a common key so that upon powering up the devices, the AP device 501 incorporates the extending device 1602 into the self-configuring secure wireless network 1600 using the common key, e.g., as previously described.

One or more wireless enabled devices 1604, e.g., wireless cameras and/or sensors, are coupled to the AP device 501 through the extending device 1602. Without the extending device 1602, the one or more wireless enabled devices 1604 would be unable to communicate with the AP device 501.

An additional wireless device 1606 is also shown, which has been subsequently added to the secure wireless network 1600 after the installation of the secure wireless network 1600 in the home security system. Hence, it is referred to as being a “new” wireless device. The additional wireless device 1606 is positioned within the extended range of the secure wireless network 1600 provided by the extending device 1602. Similar to the wireless enabled devices 502, 503, the new wireless device 1606 has also been preprogrammed with the common key so that it too can provide for self-configuration of the secure wireless network 1600.

The AP device 501 can include at least one of an Ethernet receptacle or Universal Serial Bus (USB) receptacle so that various devices such as computer 142 may be wire-connected to it, such as through an Ethernet connection 522. The AP device 501 can be configured to be in router mode. Hence, it can be referred to as being a “router” access point device.

The AP device 501 is wire-connected, such as through an Ethernet connection 521, to a network adapter 141, e.g., a modem, which accesses the Internet 120 through an ISP. Preferably, a broadband connection is used for high speed transmission of video data from the wireless camera 502 and sensor data from the wireless sensor 503. The AP device 501 includes a Dynamic Host Configuration Protocol (DHCP) server which is enabled in this case so that it may assign IP subaddresses to devices connecting through the AP device 501 to the Internet 120.

As previously explained, the AP device 501 has a software agent residing in it that automatically establishes a connection with a remote service provider server 110 upon the AP device 501 being powered up and after it has been connected to the Internet 120 through the network adapter 141, which serves as an Internet gateway. The service provider server 110 interacts with the AP device 501 and authorized devices, such as primary and secondary mobile devices 131, 132, to perform various functions and/or services as described herein.

The mobile devices 131, 132 preferably also have software agents or resident applications for such interaction with the service provider server 110. Devices that are attempting to interact with the service provider server 110 may confirm their authority to the service provider server 110, for example by providing information that uniquely identifies the requesting device, such as an Internet Protocol (IP) address, a product serial number, or a cell phone number. Alternatively, they may provide a user name and password which are authorized to interact with the self-configuring secure wireless network 1600. To facilitate such authorization procedures, the service provider server 110 stores or has ready access to such authorization information for each self-configuring secure wireless network of users who subscribe to the service.

The cameras 502 and sensors 503 can be configured as part of the self-configuring secure wireless network 1600 as described above. Additionally, the extending device 1602 can also be configured at startup. In particular, the extending device 1602 is coupled to the AP device 501 in a similar manner as the cameras 502 and sensors 503 above.

Once the extending device 1602 is coupled to the AP device 501, the one or more wireless enabled devices 1604 is added to the self-configuring secure wireless network 1600 as described above, but using the extending device 1602 to relay communications between the AP device 501 and the one or more wireless enabled devices 1604.

In as similar manner as described previously, the AP device 501 is configured to update the wireless devices including the extending device 1602 and the one or more wireless enabled devices 1604, with a new key. The new key can be generated by the AP device 501 or received from the service provider server 110. The new key can uniquely identify a user of the wireless network 1600 and can be derived using one or more unique user identifiers, such as one or more of a user telephone number, address, email address, social security number, driver's license number, or credit card number. The wireless network 1600 is re-established using the new key, which replaces the common key.

If a new wireless enable device, having the common key, is added to the wireless network 1600 at a later point in time, the AP device 501 can first re-establish the wireless network using the common key, add the new wireless enabled device to the wireless network, and then re-establish the wireless network using the new key as described above.

Additionally, the AP device 501 and subsequently use one or more updated keys, e.g., additional new keys to update the wireless network 1600. Each key can be distinct. For each updated keys, the AP device 501 distributes the updated key to each wireless enabled device in the wireless network 1600. The wireless network 1600 is re-established using the updated key.

Additional extending devices can be added, e.g., in a cascading manner or to extend the network in different directions independently. However, if only a first extending device is initially in range of the AP, the first extending device is initially added to the self-configuring wireless network. Once the first extending device is added, subsequent extending devices can be sequentially added in a similar manner as the range of the self-configuring secure wireless network is extended.

The additional wireless device 1606, added after the initial configuration of the self-configuring secure wireless network 1600 in a similar manner as described above. Additionally, as described above, a new key can be generated and distributed to devices in the self-configuring secure wireless network 1600.

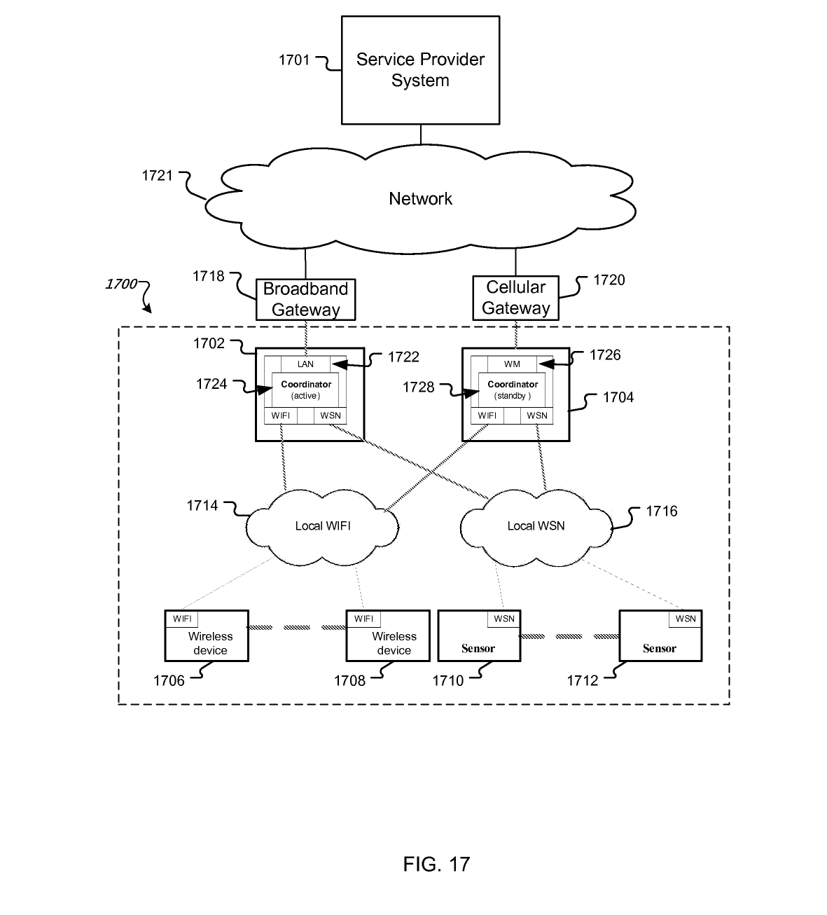

FIG. 17 illustrates a block diagram of an example system including a backup coordinator for a secure wireless network 1700. The secure wireless network 1700 can be a self-configuring wireless network as described above, which allows the secure wireless network 1700 to be automatically established upon power-up with little or no interaction. The self-configuring wireless network can generally be established in a similar manner to the self-configuring wireless networks described above.

In some alternative implementations, establishing the self-configuring wireless network includes performing a different key exchange procedure between an access point device and IP devices and/or sensors of the system than the common key described above. Regardless of the key exchange procedure, a secure wireless network 1700 is established that includes a primary access point device 1702, a number of wireless enabled devices, e.g., wireless cameras 1706, 1708 and wireless sensors 1710, 1712. Additionally, the system includes a secondary access point device 1704.

The primary access point device 1702 is connected through network 1721, e.g., the internet, to a service provider system 1701, for example, as described in detail above. In particular, the primary access point device 1702 can use a broadband gateway 1718 to the network 1721. The broadband gateway 1718 can couple the primary access point device 1702 to the internet 1721 using, e.g., DSL, fiber, cable, Ethernet, or other wired connection.

As illustrated in FIG. 17, the wireless cameras 1706 and 1708 are communicatively coupled to the primary access point device 1702 using a local WiFi network 1714. For example, the wireless cameras 1706 and 1708 can be wireless cameras for a home security system strategically positioned within and/or around a residence, business, or other location.

Additionally, as further illustrated in FIG. 17, the wireless sensors 1710, 1712 are communicatively coupled to the primary access point device 1702 using a local wireless sensor network 1716. The sensors can include security sensors for detecting movement or displacement, as well as sensors for detecting an opening of doors and windows. Other sensors providing other useful information may be included, for example, doorbell sensors, smoke detector alarm sensors, temperature sensors, and/or environmental control sensors and/or controls.

In some alternative implementations, the wireless cameras and wireless sensors communicate with the primary access point device 1702 using a single wireless network.

The primary access point device 1702 includes a wired network connection, e.g., a local area network (LAN) connection, 1722, a primary coordinator 1724, as well as wireless transmitters/receivers for the local WiFi network 1714 and wireless sensor network 1716. For example, primary the access point device 1702 can include interface logic, such as a transmitter and receiver, for communicating with the wireless devices on the secure wireless network. The interface logic may be integrated into the primary access point device 1702 or attached to it in the form of a dongle. Supported wireless technologies include WiFi, Bluetooth, Z-Wave, ZigBee, 433 MHz RF, and other Radio Frequency (RF) technologies, as described in above.

The wired network connection 1722 can include a router (not shown) allowing for a direct connection to an external network location for coupling the primary access point device 1702 to the network 1721 and eventually the service provider system 1701. In some alternative implementation, the wired network connection 1722 is coupled to a separate router device (not shown).

The primary coordinator 1724 provides traffic management from the wireless enabled devices, e.g., wireless cameras 1706 and 1708 and wireless sensors 1710, 1712, as well as communicating with the service provider system 1701. The primary coordinator 1724 performs functions for establishing the secure wireless network. In some implementations, a software agent is used by the primary coordinator 1724 such that the coordinator automatically establishes a connection with a remote service provider system 1701 when the primary access point device 1702 is connected to an Internet gateway and powered up. The remote service provider system 1701 may then request the primary coordinator 1724 to perform numerous tasks including updating the wireless key to a new key or from the new key to a newer key, transmitting data from wireless enabled network devices to authorized devices requesting such data, and adding new wireless enabled network devices to an established secure wireless network. Each key can be distinct from each other key.

The primary access point device 1702 may be configured as an intelligent router or bridge. In addition to the coordinator, the access point device includes memory for storing information such as the common key, program code for the software agent, and other items described herein.

When a sensor signals the occurrence of an event, the primary coordinator 1724 determines whether the event satisfies one or more criteria for alerting the service provider system 1701. The primary coordinator 1724 also performs functions for adding new wireless enabled devices to the secure wireless network.

The system further includes a secondary access point device 1704. The secondary access point device 1704 includes a wireless modem 1726, a secondary coordinator 1728, as well as wireless transmitters/receivers for the local WiFi network 1714 and wireless sensor network 1716.

The wireless modem 1726 can be used to communicate with the service provider system 1701. The wireless modem can communicate, for example, using one or more of a public switched telephone network (PSTN), 3G, LTE, GSM, or CDMA dongles. Another example is that the secondary access point device 1704 can use an external cellular gateway device to communicate with the service provider's network wirelessly using cellular gateway 1720. The secondary access point device 1704 can communicate with cellular gateway 1720 using, e.g., USB, serial, Ethernet, or particular wireless protocols. Thus, secondary access point device 1704 can communicate with the service provider system 1701 using either wireless modem 1726 or through cellular gateway 1720.

The secondary coordinator 1728, when activated, can perform the functions of the primary coordinator 1724. In particular, the secondary coordinator 1728 can use the wireless modem 1726 or external cellular gateway 1720 to communicate with the service provider system 1701. The secondary coordinator 1728 can also use an interface to a wireless transmitter and/or receiver to communicate with wireless cameras 1706 and 1708 and wireless sensors 1710 and 1712.

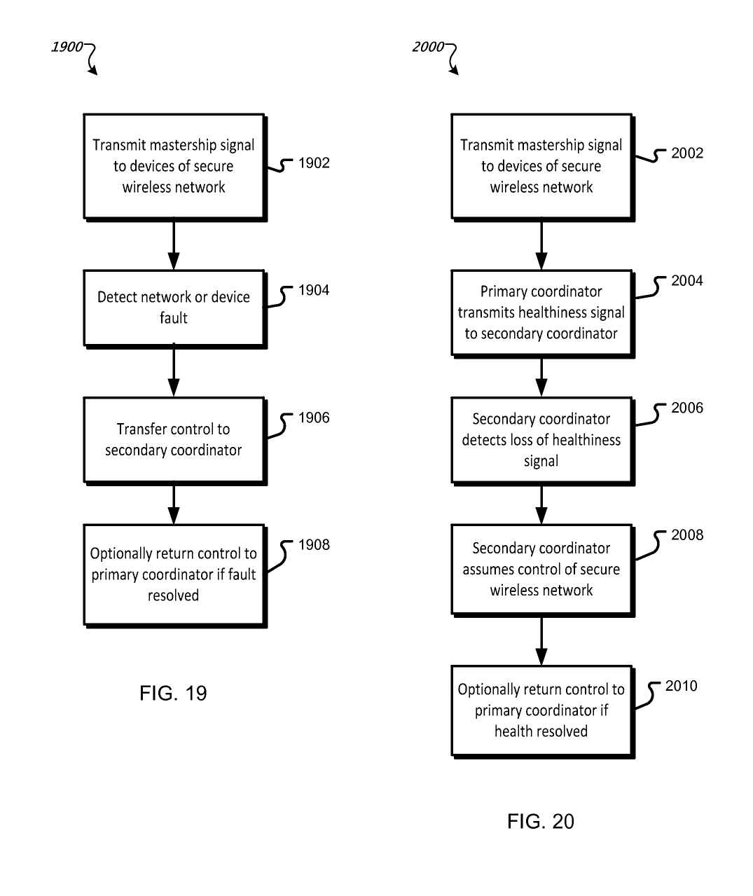

During operation, if one or more specified conditions occur, the secondary coordinator 1728 can take over the operations of the primary coordinator 1724. For example, in some implementations, if communication between the primary access point device 1702 and the network 1721 is interrupted, the secondary access point device 1704 can act as the primary access point device 1702. In some other implementations, if the primary access point device 1702 failed to send out a mastership signal, the secondary access point device 1704 can act as the primary access point device and broadcast its mastership signal. Example processes for assumption of control of the secure wireless network by a secondary coordinator are described in greater detail below with respect to FIGS. 19-20.

In some implementations, the primary coordinator 1724 periodically transmits a signal to devices in the secure wireless network 1700, e.g., the wireless cameras 1706, 1708 and wireless sensors 1710 and 1712, and the secondary coordinator 1728, indicating that the primary coordinator 1724 is in control of the secure wireless network 1700. This signal, which can be referred to as a mastership signal, indicates to the wireless enabled devices that they should communicate with the primary coordinator 1724. If the secondary coordinator 1728 assumes control of the secure wireless network 1700, the secondary coordinator 1728 transmits the mastership signal in place of the primary coordinator 1724. Additionally, in some implementations, the primary coordinator 1724 periodically transmits a healthiness signal to the secondary coordinator 1728. If the healthiness signal ceases for a specified threshold amount of time, the secondary coordinator 1728 can assume control of the secure wireless network 1700.

In some implementations, the secondary coordinator 1728 periodically transmits a healthiness signal to all devices in the local network including the primary coordinator 1724. When the secondary coordinator 1728 takes control of the local network, the primary coordinator 1724 monitors the mastership signal and healthiness signal broadcasted from the secondary coordinator 1728. When the primary coordinator 1724 recovers back from a previous failure status, the primary coordinator 1724 can immediately takes control of the local network then secondary coordinator 1728 returns to standby mode, or, alternatively, the primary coordinator 1724 can take control of the local network only when it detects loss of the healthiness signal and/or loss of the mastership signal from the secondary coordinator 1728.

Additionally, in some implementations, the secondary coordinator 1728 can also act as a repeater. In particular, the secondary coordinator 1728 can receive the wireless signals from the primary coordinator 1724 and rebroadcast them. The secondary coordinator 1728 acts as a repeater while in standby as a coordinator for the secure wireless network 1700. However, if the primary coordinator 1724 fails, e.g., based on triggering conditions described above, the secondary coordinator 1728 takes over the role of the primary coordinator 1724 and stops acting as a repeater.

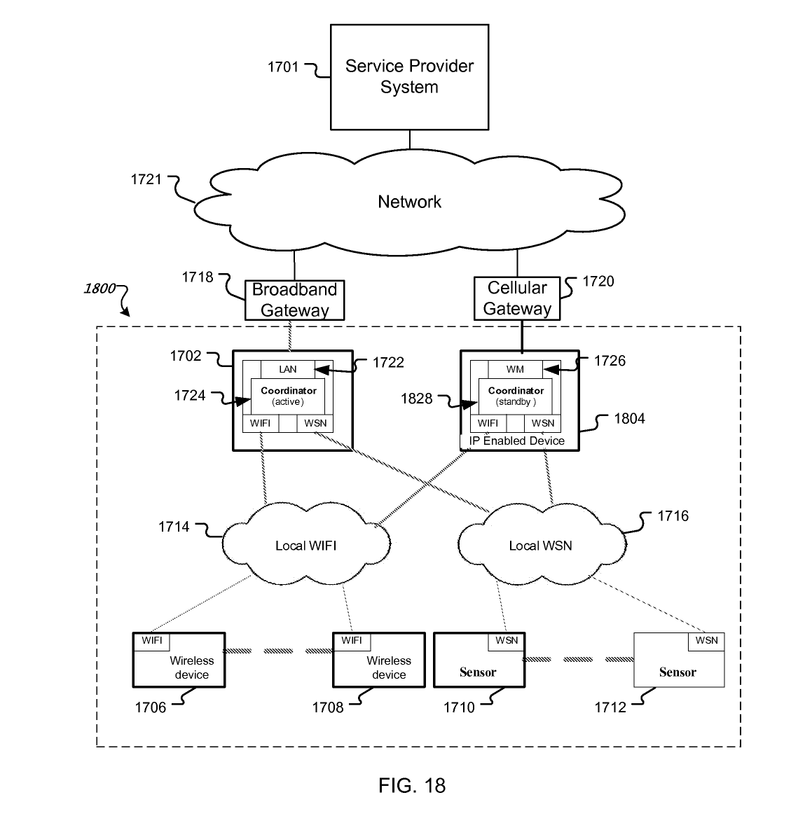

FIG. 18 illustrates a block diagram of an example system including a backup coordinator for a secure wireless network 1800. The secure wireless network 1800 can be a self-configuring wireless network as described above, which allows the secure wireless network 1800 to be automatically established upon power-up with little or no interaction.

In some alternative implementations, establishing the self-configuring wireless network includes performing a different key exchange procedure between an access point device and IP devices and/or sensors of the system than the common key described above. Regardless of the key exchange procedure, a secure wireless network 1800 is established that includes primary access point device 1702, a number of wireless enabled devices, e.g., wireless cameras 1706, 1708 and wireless sensors 1710, 1712.

The primary access point device 1702 is coupled through network 1721, e.g., the internet, to the service provider system 1701, for example, in a similar manner as described above. In particular, the primary access point device 1702 can use a broadband gateway 1718 to connect to the network 1721. The broadband gateway 1718 can couple the primary access point device 1702 to the internet 1721 using, e.g., PSTN, DSL, fiber, cable, Ethernet, or other wired connection.

As illustrated in FIG. 18, the wireless cameras 1706 and 1708 are communicatively coupled to the primary access point device 1702 using a local WiFi network 1714. Additionally, the wireless sensors 1710, 1712 are communicatively coupled to the primary access point device 1702 using a local wireless sensor network 1716. In some alternative implementations, the wireless cameras and wireless sensors communicate with the primary access point device 1702 using a single wireless network.

The primary access point device 1702 includes wired network connection, 1722, primary coordinator 1724, as well as wireless transmitters/receivers for the local WiFi network 1714 and wireless sensor network 1716.

The wired network connection 722 can include a router (not shown) allowing for a direct connection to an external network location for coupling the primary access point device 1702 to the network 1721 and eventually the service provider system 1701. In some alternative implementation, the wired network connection 1722 is coupled to a separate router device (not shown).

The primary coordinator 1724 provides traffic management from the wireless enabled devices, e.g., wireless cameras 1706 and 1708 and wireless sensors 1710, 1712, as well as communicating with the service provider system 1701. The primary coordinator 1724 performs functions for establishing the secure wireless network as described above. For example, when a sensor signals the occurrence of an event, the primary coordinator 1724 determines whether the event satisfies one or more criteria for alerting the service provider system 1701. The primary coordinator 1724 also performs functions for adding new wireless enabled devices to the secure wireless network.

The system further includes an additional wireless enabled device 1804. The additional wireless enable device 1804 is similar to the wireless enabled devices 1706 and 1708, but includes additional components, for example an IP enabled device e.g., an IP camera, with additional components. In particular, the wireless enabled device 1804 further includes a secondary coordinator 1828, a wireless modem 1726, as well as wireless transmitters/receivers for the local WiFi network 1714 and wireless sensor network 1716.

In some implementations, the wireless enable device 1804, is a wireless camera or other wireless enabled device that functions similar to other components of the secure wireless network 1800. Thus, a distinct secondary access point device is not required. The wireless enable device 1804 communicates with the primary access point device 1702 as needed, for example, to provide video content when a triggering event occurs. However, when the secondary coordinator 1828 is activated (e.g., as described above with respect to FIG. 17 as well as described below with respect to FIGS. 19-20), the wireless enable device 1804 also takes on the functions of the primary coordinator 1724 and use the wireless modem 1726 to communicate with the service provider system 1701.

The wireless modem 1726, as described above with respect to FIG. 17, can be used to communicate with the service provider system 1701. The wireless modem can communicate, for example, using one or more of a public switched telephone network (PSTN), 3G, LTE, GSM, or CDMA dongles. Another example is that the secondary access point device 1804 can use an external cellular gateway device to communicate with the service provider's network wirelessly using cellular gateway 1720. The secondary access point device 1804 can communicate with cellular gateway 1720 using, e.g., USB, serial, Ethernet, or particular wireless protocols. Thus, secondary access point device 1828 can communicate with the service provider system 1701 using either wireless modem 1726 or through cellular gateway 1720.

The secondary coordinator 1828, when activated, can perform the functions of the primary coordinator 1724. In particular, the secondary coordinator 1828 can use the wireless modem 1726 or external cellular gateway 1720 to communicate with the service provider system 1701. The secondary coordinator 1828 can also use an interface to a wireless transmitter and/or receiver to communicate with wireless cameras 1706 and 1708 and wireless sensors 1710 and 1712.

During operation, if one or more specified conditions occur, the secondary coordinator 1828 can take over the operations of the primary coordinator 1724. For example, in some implementations, if communication between the primary access point device 1702 and the network 1721 is interrupted, the secondary access point device 1804 can act as the primary access point. In some other implementations, if the primary access point device 1702 failed to send out a mastership signal, the secondary access point device 1704 can act as the primary access point device and broadcast its mastership signal. Example processes for assumption of control of the secure wireless network by a secondary coordinator are described in greater detail below with respect to FIGS. 19-20.

In some implementations, the secondary coordinator 1828 periodically transmits a healthiness signal to all devices in the local network including the primary coordinator 1724. When the secondary coordinator 1828 takes control of the local network, the primary coordinator 1724 monitors the mastership signal and healthiness signal broadcasted from the secondary coordinator 1828. When the primary coordinator 1724 recovers from a previous failure status, the primary coordinator 1724 can immediately takes control of the local network then secondary coordinator 1828 returns to standby mode, or, alternatively, the primary coordinator 1724 can take control of the local network only when it detects loss of the healthiness signal and/or loss of the mastership signal from the secondary coordinator 1828.

FIG. 19 is a flow diagram of an example process 1900 for redundant coordinator support. The method can be performed by devices of a secure wireless network, for example, the devices of secure wireless networks 1700 or 1800 of FIGS. 17 and 18, respectively. For convenience, the process 1900 will be described with respect to components of a system, e.g., a security or surveillance system, including a secure wireless network, that performs the process 1900.

The primary access point device of the system transmits 1902 a mastership signal to devices of the secure wireless network, e.g., by a primary coordinator of a primary access point device as described above with respect to FIGS. 17-18. The primary access point device can periodically broadcast the mastership signal using the secure wireless network. Devices of the secure wireless network, e.g., wireless enabled devices such as cameras and sensors, communicate with the primary coordinator based on the mastership signal. Additionally, both the primary and the secondary coordinators may respectively broadcast its healthiness signal, as described above.

The primary coordinator detects 1904 a network or device fault. The primary coordinator can detect a network error preventing communication with a service provider system. For example, a router or the network adapter of the primary access point device can malfunction. Alternatively, an external networking error can occur, e.g., at a local internet service provider or other network location between the primary access point device and the service provider system.

In another example, the primary coordinator can identify an error, e.g., using diagnostic software, that inhibits the primary coordinator's ability to perform coordination and management functions for the secure wireless network.

In response to detecting the network or device fault, the primary coordinator transfers 1906 control of the secure wireless network to a secondary coordinator. The secondary coordinator will become active once it detects a loss of the primary mastership signal. The secondary coordinator can use a different form of network communication to communicate with the service provider system. For example, the secondary coordinator can communicate with the service provider system using one or more of 3G, LTE, GSM, or CDMA. The secondary coordinator can be part of a secondary access point device.

The secondary coordinator can be inactive unless activated in response to the transfer of control. Alternatively, the secondary coordinator can be part of another wireless device active in the secure wireless network. For example, the secondary coordinator can be incorporated into a wireless camera or sensor device. While the secondary coordinator is in control of the secure wireless network, the secondary coordinator causes a corresponding mastership signal to be broadcast in a similar manner to the mastership signal of the primary coordinator. This ensures that the secondary coordinator will receive any communications from the wireless enabled devices of the secure wireless network.

In some implementations, the secondary coordinator establishes communication with the service provider system. The service provider system can validate the secondary coordinator before allowing communications. In some implementations, the service provider system determines that communication with the primary coordinator is offline. If the primary coordinator is still online, e.g., the secondary coordinator is communicating in error, then the service provider system can notify the primary coordinator of the problem. Thus, the service provider system can avoid sending communication to both the primary and secondary coordinators if an error occurs. If the primary coordinator is confirmed to be offline, the service provider system can communicate with the secondary coordinator.

The secondary coordinator can optionally return 1908 control to the primary coordinator if the fault is resolved. For example, if the network connectivity is restored, the primary coordinator can signal to the secondary coordinator by sending a healthiness signal. The secondary coordinator can transfer control to the primary coordinator. Alternatively, the primary coordinator can unilaterally resume control when the fault is cleared, for example, by resuming broadcast of the mastership signal and healthiness signal.

FIG. 20 is a flow diagram of an example process 2000 for redundant coordinator support. The method can be performed by devices of a secure wireless network, for example, the devices of secure wireless networks 1700 or 1800 of FIGS. 17 and 18, respectively. For convenience, the process 2000 will be described with respect to components of a system, e.g., a security or surveillance system, including a secure wireless network, that performs the process 2000.

The primary access point device of the system transmits 2002 a mastership signal to devices of the secure wireless network, e.g., by a primary coordinator of a primary access point device as described above with respect to FIGS. 17-18. The primary access point device can periodically broadcast the mastership signal using the secure wireless network. Devices of the secure wireless network, e.g., wireless enabled devices such as cameras and sensors, communicate with the primary coordinator based on the mastership signal.

The primary coordinator transmits 2004 a healthiness signal to the secondary coordinator. Additionally, the secondary coordinators may also broadcast its healthiness signal, as described above. The healthiness signal can be periodically transmitted to the secondary coordinator to indicate that the primary coordinator is functioning normally. The secondary coordinator can remain inactive, e.g., in a standby mode, as long as the healthiness signal is received as scheduled or within a threshold time frame.

The secondary coordinator detects 2006 a loss of the healthiness signal. For example, if the healthiness signal is not received within a specified time from a scheduled time, the secondary coordinator can determine that there is a problem with the primary coordinator.

The secondary coordinator assumes 2008 control of the secure wireless network. The secondary coordinator can use a different form of network communication to communicate with the service provider system. For example, the secondary coordinator can communicate with the service provider system using one or more of 3G, LTE, GSM, or CDMA. The secondary coordinator can be part of a secondary access point device.

The secondary coordinator can be inactive unless activated in response to the transfer of control. Alternatively, the secondary coordinator can be part of another wireless device active in the secure wireless network. For example, the secondary coordinator can be incorporated into a wireless camera or sensor device. While the secondary coordinator is in control of the secure wireless network, the secondary coordinator causes a corresponding mastership signal to be broadcast in a similar manner to the mastership signal of the primary coordinator. This ensures that the secondary coordinator will receive any communications from the wireless enabled devices of the secure wireless network.

In some implementations, the secondary coordinator establishes communication with the service provider system. The service provider system can validate the secondary coordinator before allowing communications.

The secondary coordinator can optionally return 2010 control to the primary coordinator if the fault is resolved. For example, if the network connectivity is restored, the primary coordinator can signal to the secondary coordinator by sending a healthiness signal. The secondary coordinator can transfer control to the primary coordinator. Alternatively, the primary coordinator can unilaterally resume control when the fault is cleared, for example, by broadcasting a mastership signal and healthiness signal.

In some alternative implementations, a secure wireless network, e.g., as described above with respect to FIGS. 17-20, can include more than one secondary coordinator. The additional secondary coordinators can be part of additional access point devices, other wireless enabled devices, e.g., a wireless camera with a secondary coordinator, or a combination of both.

If both the primary coordinator and a secondary coordinator fail, a subsequent secondary coordinator can take over control of the secure wireless network. When more than one secondary coordinator is present, each can have an assigned priority or order of taking control. In some implementations, when a particular secondary coordinator takes control can also depend on other factors, for example, a current bandwidth load, a number of current connections, or determined by server based on different logic depending on design, e.g. signal strength.

Although the various aspects of the present invention have been described with respect to a preferred embodiment, it will be understood that the invention is entitled to full protection within the full scope of the appended claims.

What is claimed is:

1. A self-configuring wireless system comprising:
one or more wireless network devices;
a primary access point device; and
a secondary access point device;
wherein the primary access point device and the at least one wireless network device are preconfigured with a respective key so as to enable the primary access point device to establish a secure wireless network with the at least one network device using the respective keys,
and wherein the secondary access point device is configured assume coordination for the self-configuring wireless system if a fault associated with the primary access point device occurs.

2. The self-configuring wireless system of claim 1, wherein the fault associated with the primary access point device is a loss of network connectivity to a remote service provider system.

3. The self-configuring wireless system of claim 1, wherein the fault associated with the primary access point device is a failure of the primary access point device.

4. The self-configuring wireless system of claim 1, wherein assuming coordination includes receiving a signal from the primary access point device switching control of the system.

5. The self-configuring wireless system of claim 1, wherein assuming coordination includes transmitting, by the secondary access point device, a mastership signal to each of the one or more wireless network devices.

6. The self-configuring wireless system of claim 1, wherein the secondary access point device is configured to return coordination to the primary access point device if the fault resolved.

7. The self-configuring wireless system of claim 1, wherein the primary access point device is configured to automatically establish communication with a remote service provider system.

8. The self-configuring wireless system of claim 7, wherein the secondary access point device is further configure to establish communication with the remote service provider system in response to providing coordination for the self-configuring wireless system.

9. The self-configuring wireless system of claim 8, wherein the secondary access point device uses a distinct form of network communication from the primary access point device, and wherein the form of network communication includes one or more of public switched telephone network (PSTN), 3G, LTE, GSM, or CDMA.

10. The self-configuring wireless system of claim 1, wherein the access point device is configured to update the at least one wireless network device with a first new key, and re-establish the wireless network using the first new key.

11. The self-configuring wireless system of claim 10, wherein the first new key is received from a remote service provider device, the first new key uniquely identifying a user and derived using one or more unique user identifiers, the user identifiers including one or more of a user telephone number, address, email address, social security number, driver's license number, or credit card number.

12. The self-configuring wireless system network of claim 10, wherein the access point device is configured to generate the first new key using a unique identifier of the access point device.

13. A self-configuring wireless system comprising:
a plurality of wireless network devices; and
an access point device;
wherein the access point device and the at least one wireless network device are preconfigured with a respective key so as to enable the access point device to establish a secure wireless network with the at least one network device using the respective keys, and
wherein one wireless network device of the plurality of network devices includes a secondary coordinator configured assume coordination for the self-configuring wireless system if a fault associated with the access point device occurs.

14. The self-configuring wireless system of claim 13, wherein the fault associated with the primary access point device is a loss of network connectivity to a remote service provider system.

15. The self-configuring wireless system of claim 13, wherein the fault associated with the primary access point device is a failure of the primary access point device.

16. The self-configuring wireless system of claim 13, wherein assuming coordination includes receiving a signal from the primary access point device switching control of the system.

17. The self-configuring wireless system of claim 13, wherein assuming coordination includes transmitting, by the secondary access point device, a mastership signal to each of the one or more wireless network devices.

18. The self-configuring wireless system of claim 13, wherein the secondary access point device is configured to return coordination to the primary access point device if the fault resolved.

19. A method comprising:
establishing a self-configured wireless network among a primary access point device and one or more wireless enabled devices;
periodically transmitting a mastership signal to each of the one or more wireless enabled devices indicating that the primary access point device is a primary coordinator for the self-configured wireless network;
determining that a transfer criteria has occurred; and
transferring coordination of the self-configured wireless network to a secondary coordinator.

20. The method of claim 19, wherein determining that the transfer criteria has occurred includes determining that a network connection between the primary coordinator and a remote service provider system has failed.

21. The method of claim 19, further comprising:
periodically transmitting, by the primary coordinator, a healthiness signal to each of the one or more wireless enable devices.

22. The method of claim 19, wherein determining that the transfer criteria has occurred includes determining that the healthiness signal has not been received for a specified period of time.

23. The method of claim 19, wherein determining that the transfer criteria has occurred includes determining that the mastership signal has not been received for a specified period of time.

24. The method of claim 19, further comprising:
resolving a fault condition associated with the transfer criteria, and
restoring coordination of the self-configured wireless network to the primary coordinator.
